(19) United States
(12) Patent Application Publication
(10) Pub. No.: US 2021/0317953 A1
(43) Pub. Date: Oct. 14, 2021

(54) Gas Dispensing System with Tank Pressure and Heat Management

(71) Applicant: Chart Inc., Ball Ground, GA (US)

(72) Inventor: Lukas Konfrst, Decin (CZ)

(21) Appl. No.: 17/229,972

(22) Filed: Apr. 14, 2021

Related U.S. Application Data
(60) Provisional application No. 63/009,614, filed on Apr. 14, 2020.

(51) Int. Cl. F17C 7/04; F17C 13/04

(52) U.S. Cl. CPC F17C 7/04; F17C 13/04; F17C 2223/035; F17C 2250/0626; F17C 2225/0123; F17C 2227/048; F17C 2250/043; F17C 2223/0161

(57) ABSTRACT

A system for cryogenic gas delivery includes a cryogenic tank configured to contain a cryogenic liquid and a gas within a headspace above the cryogenic liquid. The system also includes first and second vaporizers and a use outlet. A first pipe is configured to transfer gas from the headspace through the first vaporizer to the use outlet. A second pipe is configured to transfer liquid from the tank through the first vaporizer so that a first vapor stream is directed to the use outlet. A third pipe is configured to build pressure within the tank by transferring liquid from the tank through the second vaporizer so that a second vapor stream is directed back to the headspace of the tank. A first regulator valve is in fluid communication with the second pipe and opens when a pressure on an outlet side of the first regulator drops below a first predetermined pressure level. A second regulator valve is in fluid communication with the third pipe and opens when a pressure inside the tank drops below a second predetermined pressure level. The first predetermined pressure level is higher than the second predetermined pressure level.

### CLAIM OF PRIORITY

This application claims the benefit of U.S. Provisional Application No. 63/009,614, filed Apr. 14, 2020, the contents of which are hereby incorporated by reference.

### FIELD OF THE DISCLOSURE

The present disclosure relates generally to a cryogenic storage and delivery systems for providing gas to a use device or process and, more particularly, providing gas to a use device or process while managing the heat and pressure in the cryogenic tank.

### BACKGROUND

Cryogenic tanks are an efficient way of storing cryogenic fluids for use as gases. The gas is typically stored in a liquefied state because it occupies a much smaller volume. Liquefied natural gas, for example, occupies approximately 1/600^{th} the space as a liquid versus in the gaseous state. Temperature and pressure regulation of cryogenic tanks is extremely important. Liquefied gas is stored in insulated cryogenic tanks because of the low temperature requirements and typically at lower pressures. Furthermore, the stored cryogenic liquid is typically saturated, so that the gas and liquid states simultaneously exist at a desired temperature and pressure.

Use devices often require the delivery of gas from the cryogenic tank system at a specific temperature and pressure. While providing gas to use devices, the pressure and temperature in the cryogenic tank may fluctuate. When temperature and/or pressure increase too much, it may be required to vent gas to the atmosphere, causing a loss of stored product. It is, therefore, desirable to have a cryogenic delivery tank system for providing gas to a use device which can manage internal temperature and pressure and prevent loss of product.

A prior art system for dispensing gas from a cryogenic liquid storage and delivery tank, as shown in FIG. 1, includes a cryogenic tank 100 with cryogenic liquid 110 and vapor 120 in the headspace above the liquid level line 115. The cryogenic tank includes an inner shell 101 and an outer shell 102. The cryogenic tank system includes a vapor or first pipe or line 400 from cryogenic tank 100 to a product vaporizer 12 and to a distribution outlet valve 10. Pipe or line 400 can include a number of manual isolation valves, such as valve 30. Pipe or line 400 also includes an economizer regulator 6. A liquid or second line 300 leads from the liquid portion of the tank to vaporizer 12 and distribution outlet valve 10. In addition, the system includes a pressure building or third line 500 which leads from the liquid portion of the tank to pressure building vaporizer 13 and back to the tank 100, and includes a pressure building regulator 7.

When the distribution valve 10 is opened, gas from the system is taken for consumption by a use device or process. The regulator 7 is set to open at approximately 30 bar, while the economizer 6 is set to open at approximately 32 bar. Accordingly, if the tank pressure is higher than 32 bar, gaseous vapor from the tank head or top space is supposed to flow to the product vaporizer 12. However, the economizer 6 is a small regulator with a small capacity (kv or cv value) and, therefore, only a low flow rate is accommodated without a large pressure drop across the economizer. Gas flows through line 400 when the economizer 6 is open, as shown in FIG. 2 as path 401. When the pressure in the headspace of the tank drops below approximately 32 bar, economizer 6 closes.

Regardless if economizer 6 is open or closed, liquid from the bottom of the tank travels to the vaporizer 12 through liquid pipe 300 along path 301, as shown in FIG. 3, to meet the consumption requirements when the dispensing or distribution valve 10 is open.

Should the tank pressure drop below the pressure building regulator 7 set point, this regulator opens and, as illustrated in FIG. 4, liquid flows along line 501 to pressurize the tank using the vapor from the pressure building vaporizer 13.

Depending on the amount of gas taken by the use device or process at 10, the product vaporizer 12 will be flooded. Closing the distribution valve 10 will stop the gas offtake and the pressure will rise sharply in the product vaporizer 12 due to the evaporation of the residual liquid remaining therein. The generated pressure pushes the vapor and the heated liquid, which has not yet evaporated, back to the bottom of the tank. The economizer 6 is closed at that time. During frequent cycling (gas consumption, interruption, gas consumption, etc.), this process rapidly heats the liquid in the tank. After some time, the pressure in the tank will build to the main relief valve set point. The safety valves, indicated in general at 600, will then open which results in loss of a portion of the stored fluid.

For this prior art design, the economization function has a very small working window. The economization works only when there is high pressure within the tank and very low consumption by the use device or process through distribution valve 10. At higher consumptions, the flow rate and thus pressure drop across the economizer 6 increase and primarily only the liquid is taken from the tank 100. This causes the pressure to build in the tank which may require venting of cryogen from the tank.

It is desirable to provide a cryogenic delivery tank for supplying gas to use devices with improved maintenance of a desirable temperature and pressure in the cryogenic tank.

### SUMMARY OF THE DISCLOSURE

There are several aspects of the present subject matter which may be embodied separately or together in the methods, devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a system for cryogenic gas delivery includes a cryogenic tank containing a cryogenic liquid and a gas within a headspace above the cryogenic liquid. The system also includes a first vaporizer and a second vaporizer and a use outlet. A first pipe is configured to transfer gas from the headspace through the first vaporizer to the use outlet. A second pipe is configured to transfer liquid from the tank through the first vaporizer so that a first vapor stream is directed to the use outlet. A third pipe is configured to build pressure within the tank by transferring liquid from the tank through the second vaporizer so that a second vapor stream is directed back to the headspace of the tank. A first regulator valve is in fluid communication with the second pipe. The first regulator valve is configured to open when a pressure on an outlet side of the first regulator drops below a first predetermined pressure level. A second regulator valve is in fluid communication with the third pipe. The second regulator valve is configured to open when a pressure inside the tank drops below a second predetermined pressure level. The first predetermined pressure level is higher than the second predetermined pressure level.

In another aspect, a method of providing gas from a cryogenic tank to a use device while maintaining a temperature and pressure within the tank includes liquid stored in a delivery tank includes opening a dispensing valve to start distributing gas to a use device. At a first tank pressure, gas is directed through a first pipe and a first vaporizer to the use device. At a second tank pressure, liquid is directed from the tank through a second pipe and the first vaporizer to the use device. At a third tank pressure, liquid is directed from the tank through a third pipe and a second vaporizer and back to the tank. The dispensing valve is closed to stop distributing gas to a use device and any residual liquid or gas in the first vaporizer is returned back to the top of the tank by the first pipe.

### BRIEF DESCRIPTION OF THE DRAWINGS

FIG. 1 is a schematic illustration of a prior art cryogenic delivery tank system.

FIG. 2 is a schematic illustration of a first gas delivery function of the system of FIG. 1.

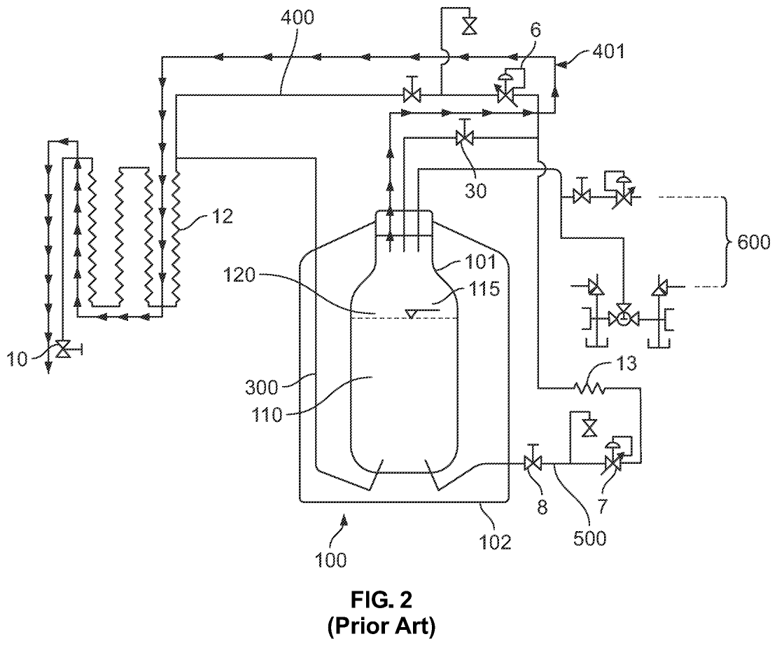

FIG. 3 is a schematic illustration of a second gas delivery function of the system of FIG. 1.

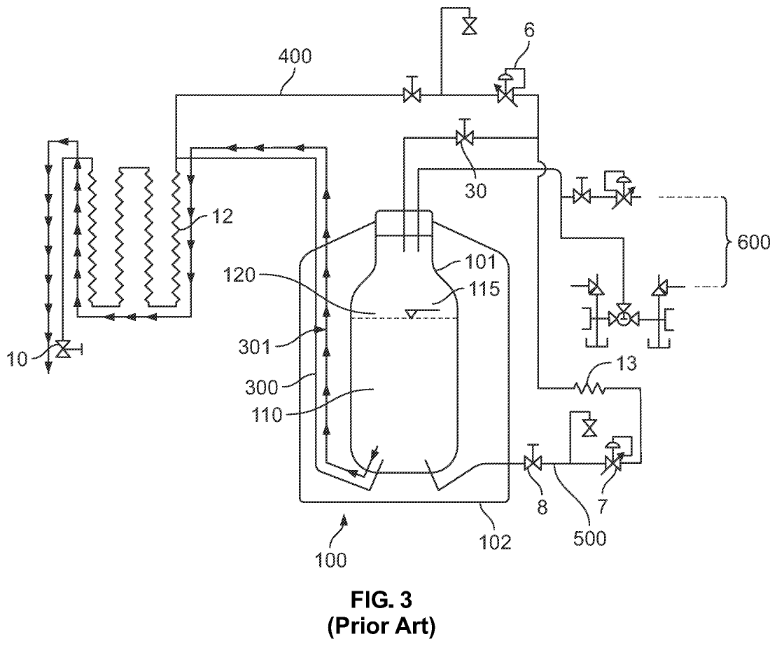

FIG. 4 is a schematic illustration of pressure building function of the system of FIG. 1.

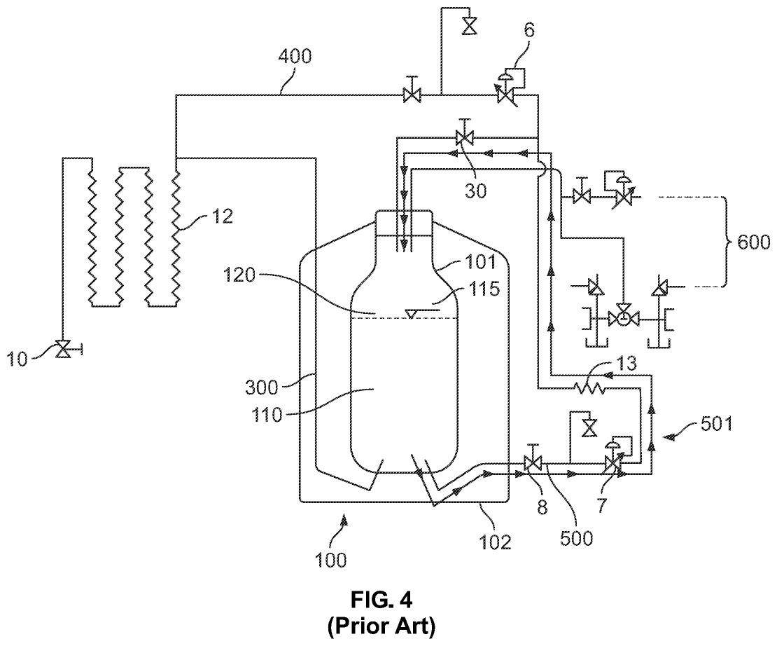

FIG. 5 is a schematic illustration of one embodiment of a delivery tank system of the current disclosure.

FIG. 6 is a schematic illustration of a first gas delivery function of the system of FIG. 5.

FIG. 7 is a schematic illustration of a second gas delivery function of the system of FIG. 5.

FIG. 8 is a schematic illustration of a pressure building function of the system of FIG. 5.

FIG. 9 is a schematic illustration of another embodiment of a delivery tank system of the current disclosure.

FIG. 10 is a schematic illustration of another embodiment of a delivery tank system of the current disclosure.

FIG. 11 is a schematic illustration of a first gas delivery function of the system of FIG. 10.

FIG. 12 is a schematic illustration of a second gas delivery function of the system of FIG. 10.

FIG. 13 is a schematic illustration of another embodiment of a delivery tank system of the current disclosure.

### DETAILED DESCRIPTION OF EMBODIMENTS

An embodiment of the disclosure provides a storage and delivery tank with a heat and pressure management function.

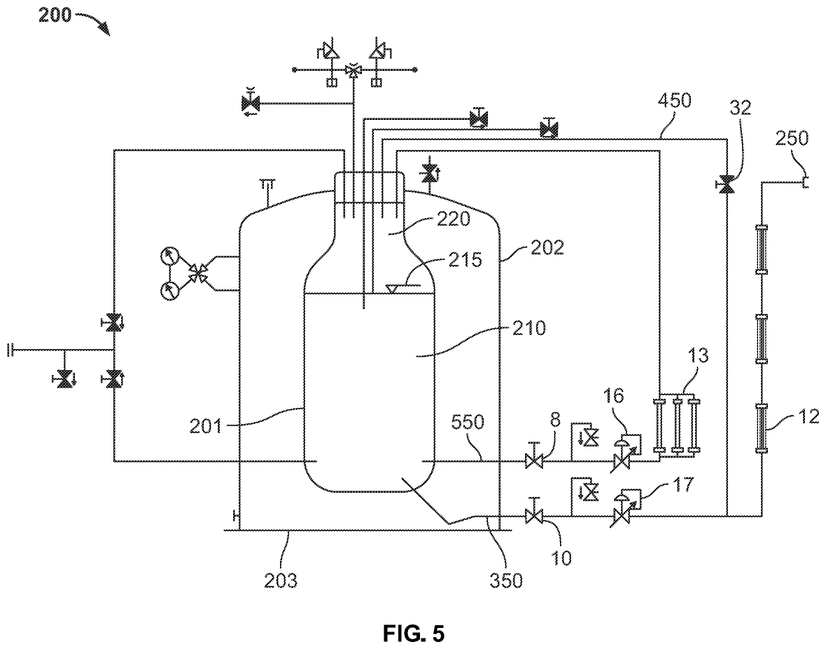

FIG. 5 illustrates a cryogenic delivery tank system 200 of the current disclosure including cryogenic tank 203. Cryogenic tank 203 is employed to store cryogenic liquid. As examples only, the cryogenic liquid can be nitrogen, helium, oxygen or any other known cryogenic fluid.

In the illustrated embodiment, cryogenic tank 203 has an inner shell 201 and an outer shell 202, where the inner shell defines an interior of the tank. Cryogenic liquid 210 is stored within the interior of the inner shell 201. Cryogenic liquid 210 occupies a specific volume of cryogenic tank 203, with the remaining volume occupied by cryogenic gas or vapor 220. The liquid level 215 is included for illustrative purposes, but the liquid level may vary, especially at different events (after delivery of gas by the system, refilling the tank with liquid, etc.).

In the illustrated embodiment, the cryogenic tank 203 is a vertical tank. In other embodiments, the tank 203 may be a horizontal tank.

Cryogenic tank 203 of the current invention, although shown as double walled, can be single or triple walled as well. The cryogenic tank can be made from copper alloy, nickel alloy, carbon, stainless steel or any other known material in the art.

Cryogenic tank 203 may have insulation between inner and outer walls (or shells) and/or may be vacuum insulated. Single or multilayer insulation of any known materials for insulation can be utilized.

The inner vessel 201 can be joined to the outer vessel 202 by one or more inner vessel support members. For example, as known in the art, the inner vessel support member may connect the neck and base of the inner vessel to the outer vessel.

Cryogenic delivery system 200 includes at least one vaporizer and preferably at least two for converting a liquefied gas to a gas for use in by a use device or process. Various types of vaporizers can be used for the vaporizers disclosed herein, such as ambient air, circulating water, electric, fuel-fired, steam, or water bath vaporizers. In one embodiment, an ambient air vaporizer is utilized. Cryogenic delivery system 200 has at least a first vaporizer 12 and a second vaporizer 13. Vaporizer 12 functions as a product vaporizer and converts liquid from the tank to vapor and warms the vapor, or warms vapor from the headspace of the tank, to the appropriate pressure and temperature for the use device. Vaporizer 13 functions as a pressure building vaporizer for raising the pressure of the cryogenic tank by taking liquid from the tank and forming a gas before returning it to the headspace of the tank. Although three vaporizers are shown for each of the product and pressure building vaporizers, more or fewer vaporizers can be included in cryogenic delivery system 200.

A number of connected transfer pipes or lines provide different functions with regard to the tank and use device as part of cryogenic delivery system 200. Cryogenic delivery system 200 includes a liquid line 350 from the liquid portion of the tank, which provides liquid for converting to gas through the vaporizer 12 and to the use outlet 250, which connects to a use device or process. Vapor line 450 provides gas from tank 203 for distribution to the use device through the use outlet 250 after moving through vaporizer 12. Pressure building line 550 directs liquid from the tank 203 to the pressure building vaporizer 13 for circulation of a resulting vapor stream back into the tank 203, so that the pressure in the tank may be increased. Although specific detail is not shown in the figures, both ends of each transfer pipe can feature a number of specific fittings. For instance, each one may comprise a removable and reusable seal. Each pipe end may also include a valve or vent. The cross-sections of this pipe and other structures can have various shapes, such as a circle, ellipsis, square, triangle, pentagon, hexagon, polygon, and other shapes.

The transfer pipes of the cryogenic delivery tank system 200 may have a number of valves. Line 450 has an isolation valve 32, while line 350 has a valve 10, that in the embodiment of FIG. 5 is an isolation valve. Line 550 has an isolation valve 8. Use outlet 250 may have a dispensing valve that is opened to provide gas to the use device or process.

The valves of the system can be, but are not limited to, glove valves, ball valves, check valves, gate valves, tilting disk check valves, swing-check or stop-check valves.

Valves can also be electromechanical valves, such as solenoid valves. In one embodiment, the dispensing valve at the use outlet 250 is a solenoid valve.

Pressure building line 550 includes pressure building regulator 16 and liquid line 350 includes liquid regulator 17. In the embodiment illustrated in FIG. 5, vapor line 450 does not have a regulator valve or economizer.

Cryogenic tank system 200 may include devices or gauges for reading different characteristics of the tank system. These devices or gauges can show pressure, temperature, differential pressure, liquid level, etc.

Cryogenic tank system 200 may also include a control system. The control system may include a controller and optionally various sensors (such as pressure and temperature sensors) positioned on or in the system. The controller may be utilized to control various parts of the cryogenic tank system such as the valves of the cryogenic tank system 200. The controller may be wired or wireless and is in communication with the optional sensors and those valves and other portions of the systems that it controls. The controller includes a processor or other computer device and can be programmable so as to regulate or initiate processes upon certain events or status information, including placing the system in the configurations described below. The controller may also provide information such as historical data or various types of indications to a user.

In the embodiment of FIG. 5, or any other embodiments of the current disclosure, the cryogenic tank system 200 includes at least one pipe for filling the tank with cryogenic liquid. In one embodiment there is a separate fill pipe and a separate withdrawal pipe. There may be other paths out of the inner vessel to fill and remove the liquid as well. The fill and withdrawal pipes may be any suitable conduit for conveying or allowing the flow of fluid therethrough.

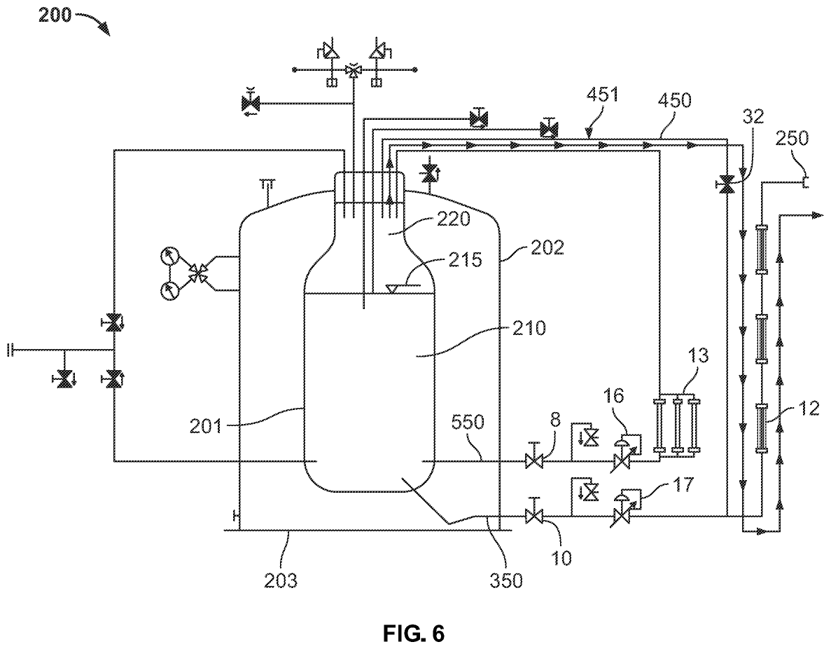

FIG. 6 illustrates a first gas delivery function by the cryogenic tank system 200. Valve 32 of line 450 is open and remains open through the operations described below. When the use device or process is connected and a dispensing valve is opened at the use outlet 250, gas transfers from the headspace of the cryogenic tank 203, so long as the pressure in line 450, and thus on the outlet side of liquid regulator 17, is higher than a specific pressure. In one embodiment, that pressure is approximately 30 bar. In other words, liquid regulator 17 is closed when the pressure on the outlet side (i.e. the pressure within line 450) is above approximately 30 bar. Gas travels from the cryogenic tank headspace through pipe 450 and product vaporizer 12 (where it may be warmed) to the use outlet 250, as indicated in general by arrows 451. Taking the vapor from the tank headspace significantly improves the overall heat management because removing the gas removes a significant amount of heat from the tank. Unlike the conventional system, there is no economizer or regulator on the line 450 to interfere with the gas transferring out of the tank headspace.

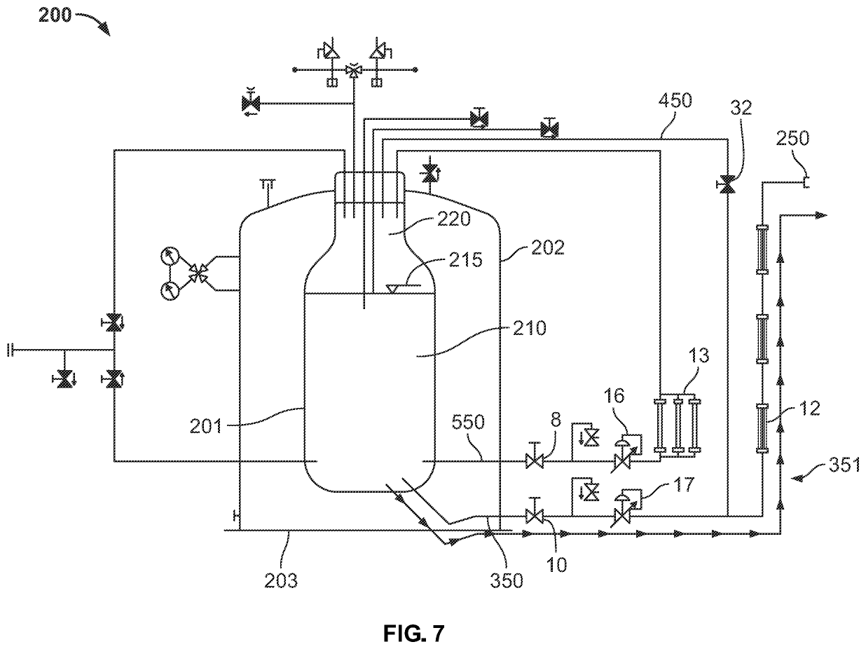

FIG. 7 illustrates a second gas delivery function by the cryogenic tank system 200. As stated previously, liquid regulator 17 on line 350 is set to a specific pressure of approximately 30 bar. When the pressure in the cryogenic tank headspace lowers due to removal of the gas/vapor from the headspace, the pressure within line 450 will drop below 30 bar and liquid regulator 17 will open. Liquid will then flow from the tank through line 350 and the regulator 17 to the product vaporizer 12. The resulting vapor will then flow through the use outlet 250 to the use device or process. The fluid path is shown in general by arrows 351 in FIG. 7.

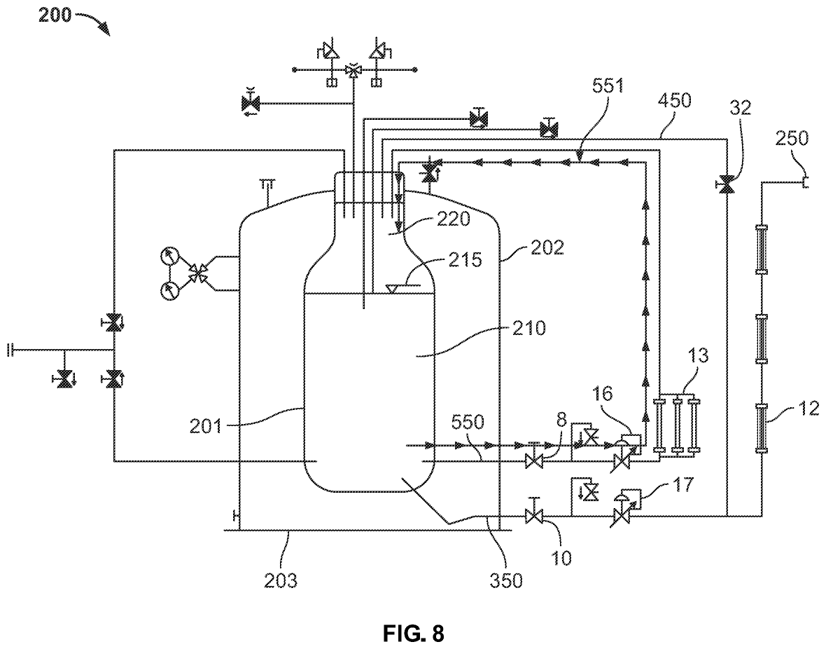

FIG. 8 illustrates a pressure increasing function by the cryogenic tank system 200. The pressure building regulator 16 on line 550 is set to open when the pressure within the tank drops to a specific pressure. In one embodiment, the specific pressure is approximately 29 bar. When the pressure in the cryogenic tank lowers to that specific pressure, due to removal of the gas/vapor from the headspace and/or liquid from the bottom of the tank, liquid will flow from the tank through line 550 to the pressure building vaporizer 13. The resulting vapor will flow back to the cryogenic tank 203, entering in the vapor headspace. The fluid path is shown in general by arrows 551 in FIG. 8. The pressure building regulator 16 closes when the pressure in the tank rises above approximately 29 bar. This maintains a desired pressure in the tank and to the product vaporizer 12.

When consumption by the use device or process is stopped, liquid remaining in the product vaporizer 12 evaporates. The pressure generated by this action pushes back the heated liquid that has not yet been able to evaporate and the residual vapor. The liquid and vapor travel back through line 450 and into the headspace of the cryogenic tank 203. The liquid regulator 17 will be closed due to higher pressure in the product vaporizer 12. The pressure inside the tank will likely rise back above 29 bar, thus closing the pressure building regulator 16. Excess heat in the form of vapor will again build at the top of the tank and enable gas/vapor removal from the top of the tank before switching to liquid withdrawal during the next gas delivery or dispensing cycle.

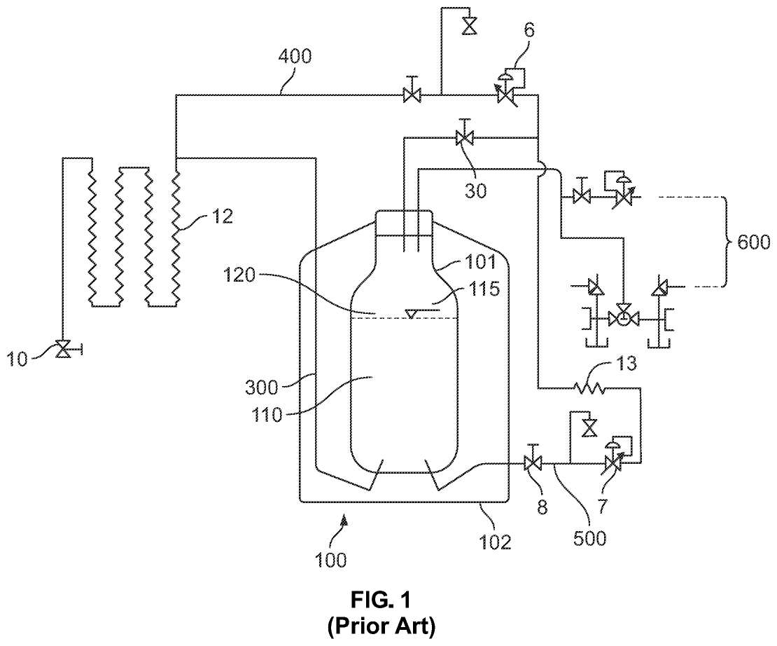

This improvement in design ensures that the cold liquid at the bottom of the tank will remain in the tank and will not be warmed as in the prior art system of FIG. 1. By keeping the liquid cold in the tank, it also maintains the thermal capacity of the stored liquid. Therefore, even if there is frequent cycling (gas consumption, interruption, gas consumption, etc.), the effects will be limited and result in less frequent opening of a relief valve and lower losses of the stored liquid.

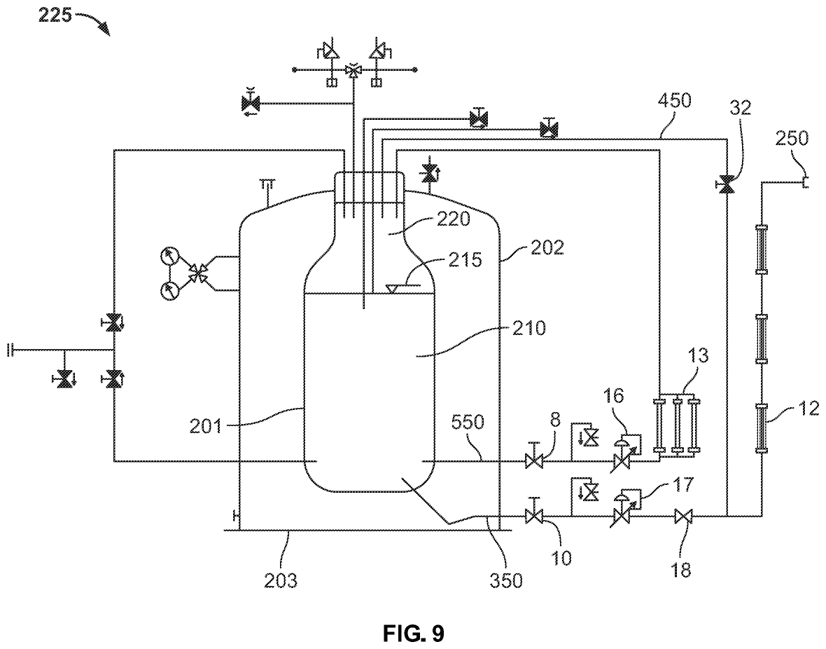

FIG. 9 illustrates an additional embodiment of the current disclosure, wherein cryogenic tank system 225 uses a check valve 18 along liquid line 350. The cryogenic tank system 225 can include all of the features of cryogenic tank system 200, but with the additional check valve 18. Check valve 18, as a one-way valve, prevents liquid flow back to the bottom of the cryogenic tank from the product vaporizer 12 after the gas consumption is stopped in the event that the pressure in the product vaporizer is below the set point of liquid regulator 17 (and thus liquid regulator 17 is open).

Alternatively, the valve 10 of FIG. 9 may be a globe check valve (and check valve 18 omitted) that prevents liquid flow back to the bottom of the cryogenic tank from the product vaporizer 12 after the gas consumption is stopped in the event that the pressure in the product vaporizer is below the set point of liquid regulator 17 (and thus liquid regulator 17 is open).

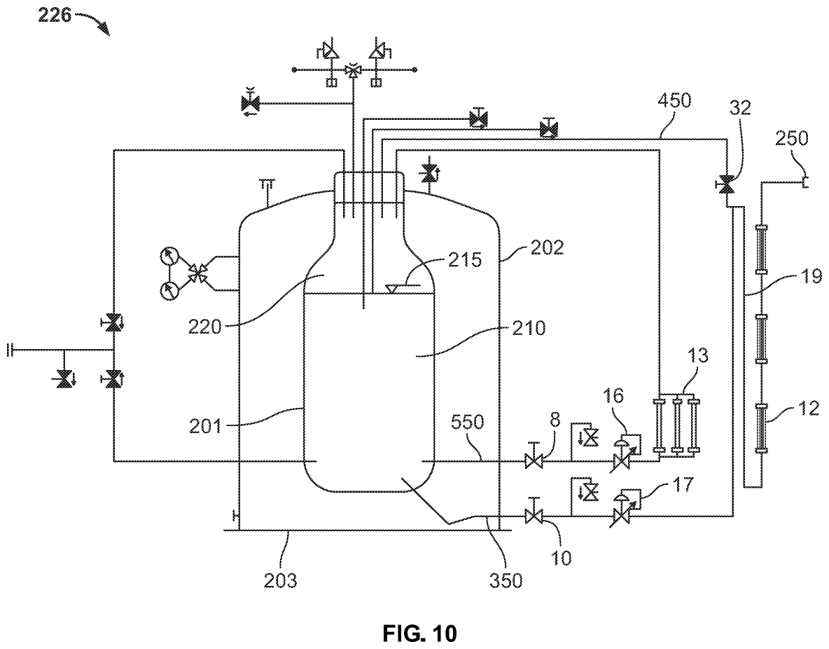

FIG. 10 illustrates an additional embodiment of the current disclosure, wherein cryogenic tank system 226 uses a loop 19 before the product vaporizer 12. The cryogenic tank system 226 can include all of the features of cryogenic tank system 200, but also includes the loop before the product vaporizer 12. Notably, in the embodiment of FIG. 10, the loop 19 features a peak portion that physically rises above the product vaporizer 12. As illustrated in FIG. 10, the vapor line 450 is attached to this peak portion of the loop. This embodiment, which may be desirable in some applications of the technology of the disclosure, prevents a portion of the liquid from the tank and line 350 from flowing simultaneously into line 450 as the remaining portion travels to the product vaporizer 12. Such flow into line 450 would result in flow to the headspace of the tank so that line 450 would act as a pressure building circuit, which is undesirable.

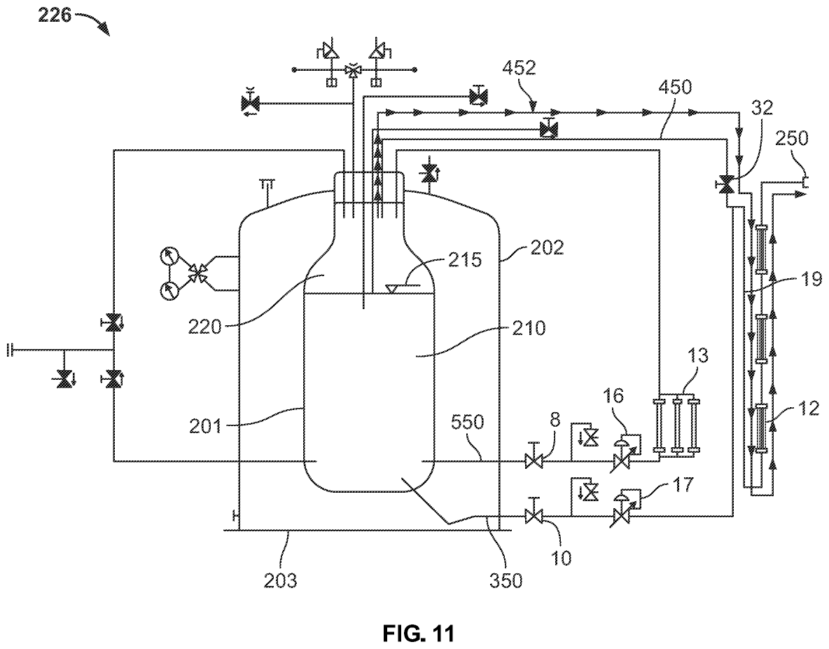

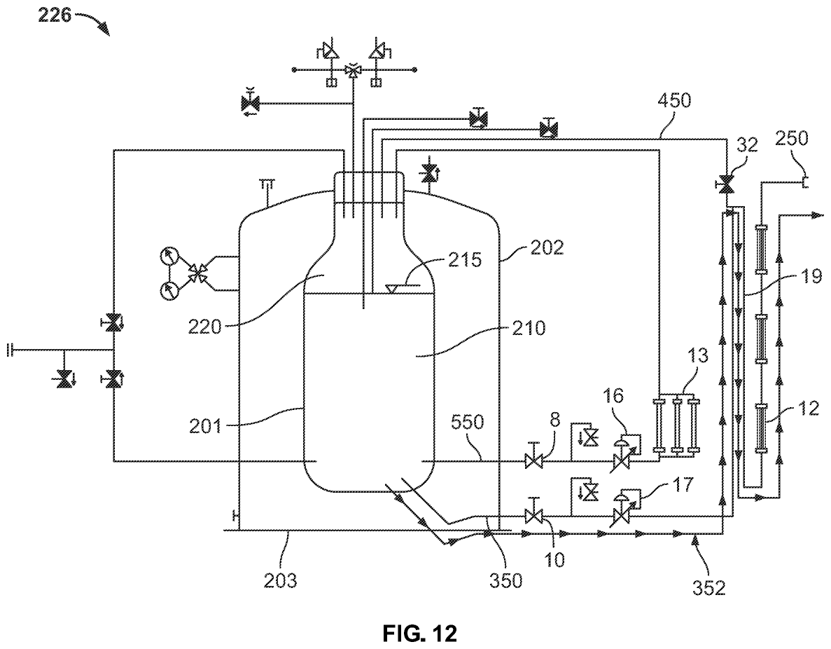

FIGS. 11 and 12 illustrate a first and second gas delivery functions for the cryogenic tank system 226. FIG. 11 shows the gas path from the headspace of the cryogenic tank 203 to use outlet 250 and the use device or process when the liquid regulator 17 is closed, indicated in general by the arrows at 452. FIG. 12 shows the liquid path from cryogenic tank 203 through the open liquid regulator 17 and vaporizer 12 to the use outlet 250 and the use device or process, indicated in general by the arrows at 352. As noted previously, loop 19 provides an additional structure to ensure that the liquid withdrawn from the cryogenic tank through line 350 does not flow into the gas line 450 through valve 32.

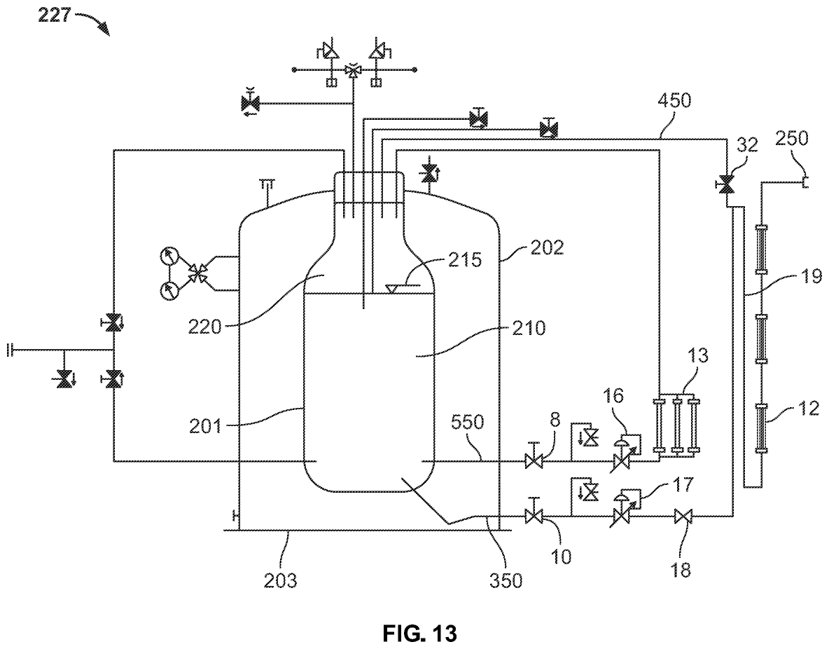

FIG. 13 illustrates an additional embodiment of the current disclosure, where cryogenic tank system 227 uses a check valve 18 along line 350 along with the loop structure 19 of FIGS. 10-12. The cryogenic tank system 227 can include all of the features and functionality of cryogenic tank system 226 of FIGS. 10-12, but with the additional check valve 18, the functionality of which is described above with respect to FIG. 9. As further described with respect to FIG. 9, in another alternative embodiment of the system of the disclosure, the valve 10 of FIG. 13 may be a globe check valve (and check valve 18 omitted).

While the preferred embodiments of the disclosure have been shown and described, it will be apparent to those skilled in the art that changes and modifications may be made therein without departing from the spirit of the disclosure, the scope of which is defined by the following claims.

What is claimed is:

1. A system for cryogenic gas delivery comprising:
a cryogenic tank comprising an inner shell and an outer shell wherein the inner shell defines an interior configured to contain a cryogenic liquid and a gas within a headspace above the cryogenic liquid;
a first vaporizer;
a second vaporizer;
a use outlet;
a first pipe configured to transfer gas from the headspace through the first vaporizer to the use outlet;
a second pipe configured to transfer liquid from the tank through the first vaporizer so that a first vapor stream is directed to the use outlet;
a third pipe configured to build pressure within the tank by transferring liquid from the tank through the second vaporizer so that a second vapor stream is directed back to the headspace of the tank;
a first regulator valve in fluid communication with the second pipe, said first regulator valve configured to open when a pressure on an outlet side of the first regulator valve drops below a first predetermined pressure level;
a second regulator valve in fluid communication with the third pipe, said second regulator valve configured to open when a pressure inside the tank drops below a second predetermined pressure level;
wherein the first predetermined pressure level is higher than the second predetermined pressure level.

2. The cryogenic tank delivery system of claim 1, wherein the system further comprises a piping loop before the first vaporizer.

3. The cryogenic tank delivery system of claim 2, wherein the loop includes a peak portion that physically rises above the first vaporizer.

4. The cryogenic tank delivery system of claim 1, further comprising a valve on the second pipe between the first regulator valve and the first vaporizer.

5. The cryogenic tank delivery system of claim 4, wherein the valve is a check valve.

6. The cryogenic tank delivery system of claim 4, wherein the valve is a globe check valve.

7. The cryogenic tank delivery system of claim 1, wherein the first pipe does not have a regulator valve.

8. The cryogenic tank delivery system of claim 1, wherein the first predetermined pressure level is 30 bar.

9. The cryogenic tank delivery system of claim 8, wherein the second predetermined pressure level is 29 bar.

10. The cryogenic tank delivery system of claim 1, wherein the first vaporizer is an ambient air vaporizer.

11. The cryogenic tank delivery system of claim 1, wherein the second vaporizer is an ambient air vaporizer.

12. The cryogenic tank delivery system of claim 1, wherein the first pipe includes an isolation valve.

13. A method of providing gas from a cryogenic tank to a use device while maintaining a temperature and pressure within the tank comprising the steps of:
opening a dispensing valve to start distributing gas to a use device;
at a first tank pressure directing gas through a first pipe and a first vaporizer to the use device;
at a second tank pressure, directing liquid from the tank through a second pipe and the first vaporizer to the use device;
at a third tank pressure, directing liquid from the tank through a third pipe and a second vaporizer and back to the tank;
closing the dispensing valve to stop distributing gas to a use device; and
returning any residual liquid or gas in the first vaporizer back to the top of the tank by the first pipe.

14. The method of claim 13, wherein the first tank pressure is at or above approximately 30 bar.

15. The method of claim 14, wherein the second tank pressure is at or below approximately 30 bar.

16. The method of claim 15, wherein the third tank pressure is at or below approximately 29 bar.

17. The method of claim 13, further comprising directing liquid or gas through a loop before the first vaporizer.

18. The method of claim 13, wherein the second line further comprises a regulator which opens at the second tank pressure, allowing liquid to flow through the second line to the first vaporizer.

19. The method of claim 13, wherein the third line further comprises a regulator which opens at the third tank pressure, allowing liquid to flow through the third line to the second vaporizer.
